(19) United States
(12) Patent Application Publication
(10) Pub. No.: US 2021/0390335 A1
(43) Pub. Date: Dec. 16, 2021

(54) GENERATION OF LABELED SYNTHETIC DATA FOR TARGET DETECTION

(71) Applicants: Chevron U.S.A. Inc., San Ramon, CA (US); University of Houston System, Houston, TX (US)

(72) Inventors: Xunsheng Du, Houston, TX (US); Shuxing Cheng, Houston, TX (US); Christian E. Haselwimmer, San Ramon, CA (US); Zhu Han, Houston, TX (US)

(21) Appl. No.: 17/344,033

(22) Filed: Jun. 10, 2021

Related U.S. Application Data
(60) Provisional application No. 63/038,064, filed on Jun. 11, 2020.

(51) Int. Cl. G06K 9/62; G06K 9/00; G06N 3/04; G06N 3/08

(52) U.S. Cl. CPC G06K 9/6217; G06N 3/088; G06N 3/0454; G06K 9/0063

(57) ABSTRACT

A synthetic image of a target is generated and combined with an image of a background to generate a synthetic training image for the target. The synthetic image of the target is inserted as a patch into the background image. The synthetic training image for the target is labeled as including a depiction of the target based on insertion of the synthetic training image into the background image. The location in which the target is depicted in the synthetic training image is automatically determined based on the location into which the synthetic image of the target is inserted into the background image.

### CROSS-REFERENCE TO RELATED APPLICATION

The present application claims the benefit of U.S. Provisional Application No. 63/038,064, entitled “Buffelgrass Detection by Unmanned Aerial Vehicle Monitoring with High-Fidelity Data Augmentation by Vector Quantised Generative Model,” which was filed on Jun. 11, 2020, the entirety of which is hereby incorporated herein by reference.

### FIELD

The present disclosure relates generally to the field of generating labeled synthetic data for target detection by inserting a synthetic depiction of a target into a depiction of a background environment.

### BACKGROUND

Object recognition models may be used to identify things depicted within images. Proper training of object recognition models may require labeled training data of sufficient quantity. Labeling the training data may require both identification of images that depict a thing within the images and identification of portions of the images that contain the depiction of the thing. Manually labeling the training data may be difficult and time consuming. Additionally, for a sparsely appearing thing, capturing sufficient number of images that depict the thing may be challenging.

### SUMMARY

This disclosure relates to generating labeled synthetic data for target detection. A synthetic depiction of a target may be generated. A depiction of a background environment may be obtained. A synthetic training image of the target may be generated by inserting the synthetic depiction of the target into the depiction of the background environment. Insertion of the synthetic depiction of the target into the depiction of the background environment may result in labeling of the synthetic training image of the target for training of a target detection model.

A system for generating labeled synthetic data for target detection may include one or more electronic storage, one or more processors and/or other components. The electronic storage may store information relating to a target, information relating to a synthetic depiction of a target, information relating to a background environment, information relating to a depiction of a background environment, information relating to a synthetic training image, information relating to insertion of a synthetic depiction of a target into a depiction of a background environment, information relating to labeling of a synthetic training image, information relating to a target detection model, information relating to training of a target detection model, and/or other information.

The processor(s) may be configured by machine-readable instructions. Executing the machine-readable instructions may cause the processor(s) to facilitate generating labeled synthetic data for target detection. The machine-readable instructions may include one or more computer program components. The computer program components may include one or more of a target component, a background component, a generation component, and/or other computer program components.

The target component may be configured to generate one or more synthetic depictions of a target. In some implementations, the synthetic depiction(s) of the target may be generated using one or more variational autoencoders. In some implementations, a variational autoencoder may be a vector quantized variational autoencoder. In some implementations, the synthetic depiction(s) of the target may be generated using one or more generative adversarial networks. In some implementations, a synthetic depiction of the target may be modified for inclusion in a synthetic training image.

The background component may be configured to obtain one or more depictions of a background environment. In some implementations, obtaining a depiction of the background environment may include generating the depiction of the background environment. In some implementations, a depiction of the background environment may be captured via aerial photography. In some implementations, the background environment may include a homogeneous environment.

The generation component may be configured to generate one or more synthetic training images of the target. A synthetic training image may be generated by inserting one or more synthetic depictions of the target into a depiction of the background environment. Insertion of the synthetic depiction(s) of the target into the depiction of the background environment may result in labeling of the synthetic training image of the target for training of one or more target detection models.

In some implementations, the labeling of the synthetic training image for training of the target detection model may include identification of the synthetic training image as including depiction(s) of the target. In some implementations, the labeling of the synthetic training image for training of the target detection model may further include determination of location(s) of the synthetic depiction(s) of the target in the synthetic training image.

In some implementations, a synthetic training image may simulate a view of the target captured via aerial photography.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for generating labeled synthetic data for target detection.

FIG. 2 illustrates an example method for generating labeled synthetic data for target detection.

FIG. 3 illustrates an example generation of a synthetic training image.

FIGS. 4A and 4B illustrate example synthetic training images.

FIG. 5 illustrates an example process for generating and using labeled synthetic data for target detection.

### DETAILED DESCRIPTION

The present disclosure relates to generating labeled synthetic data for target detection. A synthetic image of a target is generated and combined with an image of a background to generate a synthetic training image for the target. The synthetic image of the target is inserted as a patch into the background image. The synthetic training image for the target is labeled as including a depiction of the target based on insertion of the synthetic training image into the background image. The location of the target depicted in the synthetic training image is determined based on programmatic approach consisting of pre-designed algorithm or probabilistic distribution.

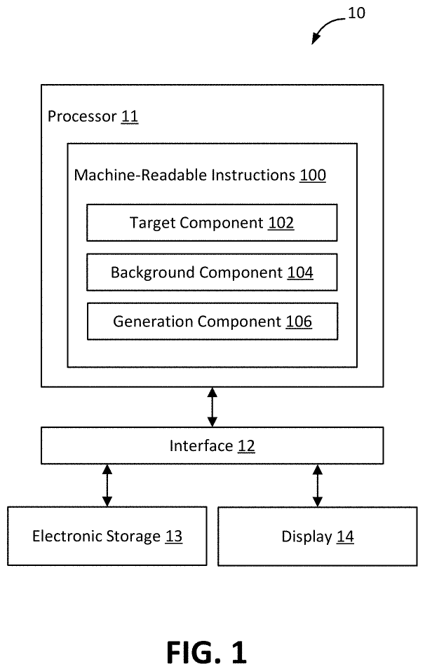

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. A synthetic depiction of a target may be generated by the processor 11. A depiction of a background environment may be obtained by the processor 11. A synthetic training image of the target may be generated by the processor 11 by inserting the synthetic depiction of the target into the depiction of the background environment. Insertion of the synthetic depiction of the target into the depiction of the background environment may result in labeling of the synthetic training image for training of a target detection model.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to a target, information relating to a synthetic depiction of a target, information relating to a background environment, information relating to a depiction of a background environment, information relating to a synthetic training image, information relating to insertion of a synthetic depiction of a target into a depiction of a background environment, information relating to labeling of a synthetic training image, information relating to a target detection model, information relating to training of a target detection model, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present information relating to a target, information relating to a synthetic depiction of a target, information relating to a background environment, information relating to a depiction of a background environment, information relating to a synthetic training image, information relating to insertion of a synthetic depiction of a target into a depiction of a background environment, information relating to labeling of a synthetic training image, information relating to a target detection model, information relating to training of a target detection model, information relating to usage of a target detection model, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate generating labeled synthetic data for target detection. The machine-readable instructions 100 may include one or more computer program components. The machine-readable instructions 100 may include a target component 102, a background component 104, a generation component 106, and/or other computer program components.

The target component 102 may be configured to generate one or more synthetic depictions of a target. Generating a synthetic depiction of a target may include creating, storing, making, producing, and/or otherwise generating the synthetic depiction of the target. Generating a synthetic depiction of a target may include generating an image including the synthetic depiction of the target. In some implementations, target component 102 may obtain previously generated synthetic depiction(s) of a target (e.g., retrieve the synthetic depiction(s) stored in memory). Other generations of a synthetic depictions of a target are contemplated.

A target may refer to an object of interest. A target may refer to a living thing or a non-living thing. A target may refer to an object or a thing for which training data is desired to be generated. A target may refer to the entirety of a thing or one or more parts of a thing. A target may refer to one or more characteristics/traits/features of a thing. For example, a target may include a structure (e.g., building, pipe), a vehicle, an animal, a person, a tool (e.g., drill bit), fluid (e.g., fluid spill), gas (e.g., gas leakage), a bubble (e.g., fluid bubble distributed in the images captured in the experimental fluid dynamics), damage (e.g., wound, imperfections, cracks, corrosion), and/or other thing/parts of a thing. Other types of targets are contemplated.

A depiction of a target may refer to a visual representation of the target. A depiction of a target may be included in one or more images. A synthetic depiction of a target may refer to a depiction of a target that imitates a real depiction of a target. A synthetic depiction of a target may refer to a depiction of a target that is generated by a computer, rather than captured through an image capture device (e.g., camera). A synthetic depiction of a target may refer to a simulated depiction of the target. For example, the target component 102 may be configured to generate “fake” images of the target.

A synthetic depiction of a target may refer to generated depiction of the target that simulates how the target looks in real life. A synthetic depiction of a target may simulate a view of the target that would be captured by a regular camera (visible light depiction of the target). A synthetic depiction of a target may simulate a view of the target that would be captured by a non-visible light camera (e.g., nonvisible light depiction of the target, such as thermal/IR depiction of the target).

Synthetic depictions of a target may be used to generate training data to be used in training a target detection model for the target. A target detection model may refer to a tool/process/program that detects a target. A target detection model may refer to a tool/process/program that can distinguish a depiction of a target from depictions of other things. Training data may be used to train a target detection model. Training data may enable the target detection model to properly distinguish a depiction of a target from depictions of other things.

The synthetic depictions of the target generated by the target component 102 may be used to generate training data, and the training data may be used to training a target detection model that can detect (e.g., identify, recognize) the target within images. Multiple synthetic depictions of a target may be generated to create diverse representation of the target. That is, rather than generating same depictions of a target, the target component 102 may generate different synthetic depictions of the target. Differences in the synthetic depictions of the target may be used to create variance/diversity within the training data for the target detection model.

Generation of the synthetic depictions of the target may enable training data to be generated without/with less capture of real depiction of the target. To adequately train a target detection model, a sufficient quantity of training data may be required. Having insufficient number of images of the target may result in poor training of the target detection model, which may result in poor detection of the target by the target detection model. Gathering sufficient number of images to be used as training data may be difficult. For example, the target may be uncommon, and it may be difficult to find the target in real life. The target may be in locations where capturing depictions of the target is difficult. Rather than attempting to find and capture depictions of the target in real life, the synthetic depictions of the target may be generated to take place of and/or to be used in addition to real depictions of the target. The synthetic depictions of the target may be used to generate synthetic training images, and the synthetic training images may be as training data (e.g., in place of real images of the target, in addition to real images of the target) for a target detection model.

In some implementations, the synthetic depiction(s) of the target may be generated using one or more variational autoencoders. A variational autoencoder, rather than using a fixed latent space, may impose a prior (e.g., a normal distribution) to present a variational and continuous distribution of latent code to generate synthetic depiction(s) of the target. In some implementations, a variational autoencoder may be a vector quantized variational autoencoder. A vector quantized variational autoencoder may utilize quantization of latent vectors to construct a discrete and learnt distribution for latent space representation (form of dictionary learning). To enable training of a vector quantized variational autoencoder to generate synthetic depiction of the target, conditional propagation of gradients may be used. In the conditional propagation, gradients may be counted during forward propagation but ignore during backward propagation (different gradient for forward and backward propagation).

In some implementations, the synthetic depiction(s) of the target may be generated using one or more generative adversarial networks. A generative adversarial network may generate synthetic depiction(s) of the target from a random latent space.

In some implementations, a synthetic depiction of the target may be modified for inclusion in a synthetic training image. Before a synthetic depiction of the target is included in a synthetic training image, the synthetic depiction of the target may be modified. Modifying the synthetic depiction of the target may generate more variance/diversity in the training data. For example, a single synthetic depiction of the target may be modified to generate multiple variances of the target, and individual variances of the target may be used to generate the synthetic training images. Modification of a synthetic depiction of a target may include one or more changes in visual characteristics of the synthetic depiction. For example, after a synthetic depiction of a target has been generated using a variational autoencoder or a generative adversarial network, the visual characteristics of the synthetic depiction may be modified to generate additional versions of the synthetic depiction. For example, the orientation of the synthetic depiction may be changed (e.g., flipped, rotated) and/or pixel values of the synthetic depiction may be changed (e.g., change in contrast, brightness, color balance). Other modification of the synthetic depiction of the target are contemplated.

The background component 104 may be configured to obtain one or more depictions of a background environment. Obtaining a depiction of a background environment may include one or more of accessing, acquiring, analyzing, determining, examining, identifying, generating, loading, locating, opening, receiving, retrieving, reviewing, selecting, storing, and/or otherwise obtaining the depiction of the background environment. For example, the background component 104 may obtain depiction(s) of a background environment stored in one or more locations (e.g., electronic storage 13, electronic storage of a device accessible via a network). As another example, the background component 104 may generate depiction(s) of a background environment (using same/similar process as the target component 102 in generating depiction(s) of a target).

A background environment may refer to a surrounding, an area, and/or a scenery. A background environment may include one or more moving things and/or one or more static things. A background environment may include one or more living things and/or one or more non-living things. A background environment may refer to a location in which a target is desired to be placed for generation of training data. A background environment may include a homogenous environment. A homogeneous environment may include/consist of same/similar things. A background environment may include a heterogenous environment. A homogeneous environment may include/consist of different things. For example, a background environment for a target may include a geographic location, a setting (e.g., grasslands, forests, water-covered area, desert, snow-covered area, ice-covered area), a structure (e.g., building, pipe, container), a thing, and/or other background environment for a target.

In some implementations, a depiction of a background environment may be captured via aerial photography. For example, an image capture device on an aerial device (e.g., drone, unmanned aerial vehicle) may be used to capture an image of a particular location from air. In some implementations, a depiction of a background environment may be captured via underwater photography. For example, an image capture device on an underwater device (e.g., underwater drone, unmanned underwater vehicle) may be used to capture an image of a particular location under the water. Other capture of a depiction of a background environment is contemplated.

The generation component 106 may be configured to generate one or more synthetic training images of the target. Generating a synthetic training image of a target may include creating, storing, making, producing, and/or otherwise generating the synthetic training image of the target. The generation component 106 may be configured to generate a synthetic training image of a target by using one or more synthetic depictions of the target, one or more depictions of a background environment, and/or other information. A synthetic training image of a target may be generated to include one or multiple synthetic depictions of the target. A synthetic training image of a target may be generated to include depiction of a single background environment or depictions of multiple background environments. Other generations of a synthetic training image of a target are contemplated.

A synthetic training image may refer to a generated image to be used as training data for one or more target detection models. A synthetic training image may refer to a training image that includes one or more synthetic depictions of the target. A synthetic training image may be generated by inserting one or more synthetic depictions of the target into a depiction of the background environment. For example, a “fake” image of a target generated by the target component 102 may be inserted in an image of a background environment obtained by the background component 104. A synthetic depiction of a target may be inserted as an image patch into the image of the background environment. The synthetic depiction(s) of the target may be blended with the depiction of the background environment to make the synthetic training image look more natural.

In some implementations, one or more characteristics of the synthetic training image may be randomly determined. For example, the number of target depictions inserted into the background depiction, the variance of the target depictions, and/or the location of the background depiction (insertion location) into which the target depiction(s) are inserted may be randomly determined. In some implementations, one or more characteristics of the synthetic training image may be controlled (by the user, by the system 10). For example, the number of target depictions inserted into the background depiction, the variance of the target depictions, and/or the location of the background depiction into which the target depiction(s) are inserted may be controlled. The insertion location may refer to an area of the background depiction into which the target depiction is inserted. The insertion location may be defined by the center of the area, the boundary of the area, the shape of the area, and/or other characteristics of the area into which the target depiction is inserted.

For example, “fake” image(s) of fluid spill (e.g., oil spill) may be inserted into image(s) of a particular setting (e.g., grasslands, forests, water-covered area, desert, snow-covered area, ice-covered area) to simulate how the fluid spill would look in the setting. “Fake” images of damage (e.g., cracks, corrosion) may be inserted into image(s) of a particular structure (e.g., building, pipe, container) or a particular thing (e.g., drill bit) to simulate how the damage to the structure/thing would look. “Fake” images of a thing (e.g., person, vehicle) may be inserted into image(s) of a location (e.g., fields, roads) to simulate how the thing would look in the location. “Fake” images of bubbles may be inserted into image(s) of fluid to simulate how bubbles look inside the fluid. Other combinations of target depictions and background environment depictions for generation of synthetic training images are contemplated.

In some implementations, a synthetic training image of a target may include one or more real depictions of a target. That is, a synthetic training image of a target may be generated by inserting both real and fake images of the target into a background environment image.

In some implementations, a synthetic training image may simulate a view of the target captured via aerial photography. That is, the synthetic training image may simulate a view of the target that could be captured by an image capture device on an aerial device. In some implementations, a synthetic training image may simulate a view of the target captured via underwater photography. That is, the synthetic training image may simulate a view of the target that could be captured by an image capture device on an underwater device.

Insertion of the synthetic depiction(s) of the target into the depiction of the background environment may result in labeling of the synthetic training image of the target for training of one or more target detection models. The synthetic training image generated by inserting the synthetic depiction(s) of the target into the depiction of the background environment may result in automatic labeling of the synthetic training image. Rather than separately/manually labeling the synthetic training image, the synthetic training image may be automatically labeled using the information on the generation of the synthetic training image (e.g., information on what target was inserted into the synthetic training image, information on where the depiction of the target was inserted in the synthetic training image). The identity of the target may be known and the location in which the depiction of the target was inserted to generate the synthetic training image may be known. The identity of the target and the location of insertion may be used to label the synthetic training image. Thus, the generation component 106 may generate synthetic training image that are automatically labeled.

In some implementations, labeling of a synthetic training image for training of a target detection model may include identification of the synthetic training image as including depiction(s) of the target. That is, the synthetic training image may be labeled for use in training the target detection model by identifying that the synthetic training image includes the inserted target. Identification of the synthetic training image as including depiction(s) of the target may include providing/inserting a description of the target (e.g., target identity) into the label for the synthetic training image.

In some implementations, labeling of a synthetic training image for training of a target detection model may further include determination of location(s) of the synthetic depiction(s) of the target in the synthetic training image. That is, the synthetic training image may be labeled for use in training the target detection model by determining insertion location (e.g., region of interest location, bounding box location) of the target depiction in the synthetic training image. The insertion location of the target depiction of be determined based on generation of the synthetic training image. Rather than analyzing the synthetic training image to identify the location of the target, where the target was inserted during the generation of the synthetic training image may be used as the insertion location. That is, because the generation component 106 generated the synthetic training image by inserting the depiction(s) of the target (synthetic target image patch) into the depiction of the background environment (background image), the generation component 106 already knows the insertion location of the target and may label the synthetic training image with the insertion location. Thus, in addition to generating the synthetic training image, the generation component 106 may label the synthetic training image with information on (1) what target is depicted within the synthetic training image, and (2) where within the synthetic training image the target depiction(s) are contained. Such generation of the synthetic training image may eliminate the need for manually labeling training data. Such generation of the synthetic training image may increase the amount of training data available. Such generation of the synthetic training image may allow for adequate/proper training of target detection models to detect sparsely appearing things. Such generation of the synthetic training image may increase accuracy of target detection models.

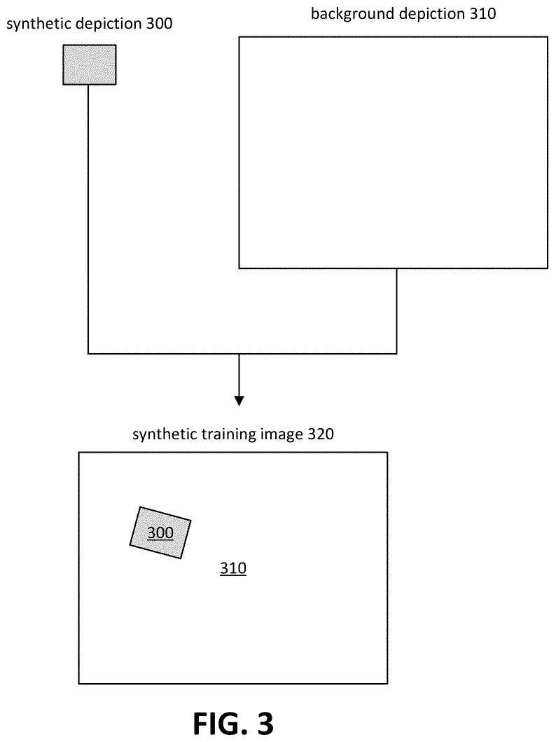

FIG. 3 illustrates an example generation of a synthetic training image. A synthetic depiction 300 of a target may be generated. A background depiction 310 of a background environment may be obtained. The synthetic depiction 300 of the target may be inserted into the background depiction 310 of the background environment to generate a synthetic training image 320. The synthetic training image 320 may be labeled as including the depiction of the target and with the location of the depiction of the target (e.g., upper-left area with the depiction rotated to the right).

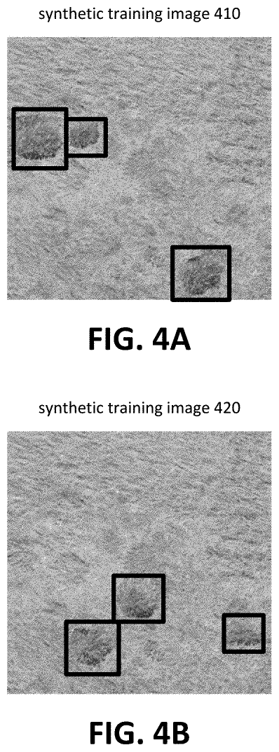

FIGS. 4A and 4B illustrate example synthetic training images 410, 420. The synthetic training images 410, 420 may include the same background image of a grassland. The synthetic training images 410, 420 may be generated by inserting three synthetic depictions of a target (e.g., buffelgrass) into the background image of the grassland. The synthetic training images 410, 420 may include different synthetic depictions of the target (e.g., differently generated synthetic depictions, differently modified synthetic depictions). The synthetic training images 410, 420 may include the synthetic depictions of the target in different locations. The synthetic training images 410, 420 may be labeled as including the target and with information on the location of the target depictions within the images.

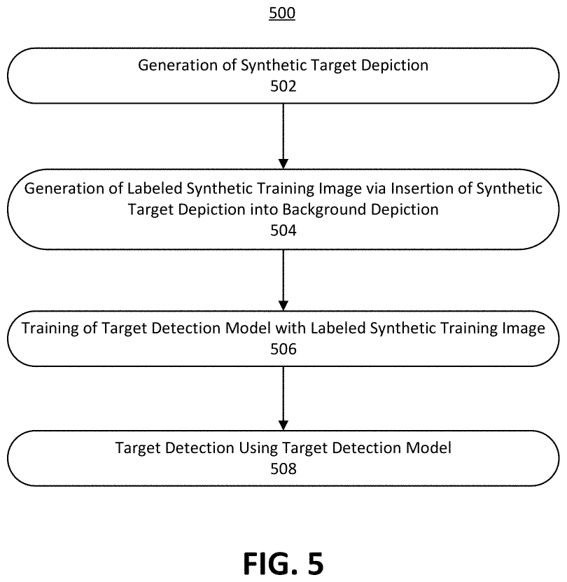

FIG. 5 illustrates an example process for generating and using labeled synthetic data for target detection. At a step 502, a synthetic target depiction may be generated. The synthetic target depiction may include a synthetic depiction of a target. At a step 504, labeled synthetic training image may be generated by inserting the synthetic target depiction into a background depiction. The background depiction may include a depiction of a background environment. The synthetic training image may be labeled with (1) the type of target that was inserted into the background depiction, and (2) the location (e.g., region of interest location, bounding box location) of the background depiction into which the target was inserted. At a step 506, a target detection model for detecting the target may be trained using the labeled synthetic training image. The labeled synthetic training image may be used as the training data for the target detection model. At a step 508, the target detection model may be used to detection presence of the target in one or more images. The results of the target detection may be presented within one or graphical user interface and/or one or more displays.

The training data may include both labeled synthetic training images and labeled real training images. In some implementations, the ratio of labeled synthetic training images and labeled real training images in the training data may be set/adjusted to increase (e.g., maximize) the detection accuracy of the target detection model. In some implementations, the target detection model may be trained using transfer learning. Transfer learning may utilize weights of a pretrained target detection model as initial weights of the target detection model. For example, weights of a neural network trained using training data relating to the target may be used as initial weights of a neural network to detect the target. For instance, weights of a neural network trained using training data of vegetation may be used as initial weights of a neural network to detect a specific plant. Use of transfer learning may change the desired ratio of labeled synthetic training images and labeled real training images in the training data. For example, with transfer learning, less real data may be required to increase (e.g., maximize) the detection accuracy of the target detection model. Use of transfer learning may reduce the ratio of real data to synthetic data that is required to achieve a specific/highest precision with the target detection model.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

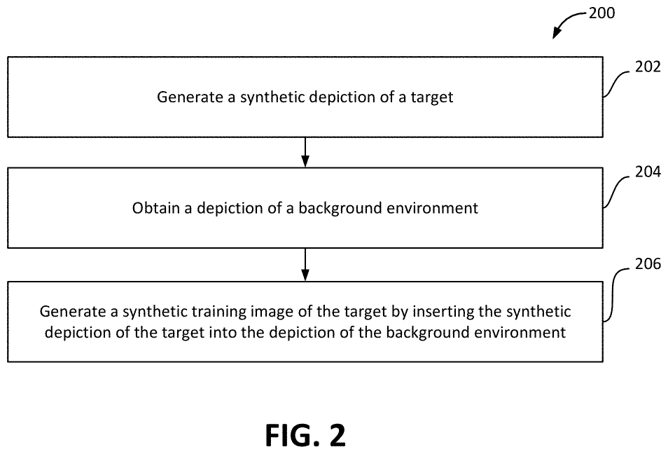

FIG. 2 illustrates method 200 for generating labeled synthetic data for target detection. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, a synthetic depiction of a target may be generated. In some implementation, operation 202 may be performed by a processor component the same as or similar to the target component 102 (Shown in FIG. 1 and described herein).

At operation 204, a depiction of a background environment may be obtained. In some implementation, operation 204 may be performed by a processor component the same as or similar to the background component 104 (Shown in FIG. 1 and described herein).

At operation 206, a synthetic training image of the target may be generated by inserting the synthetic depiction of the target into the depiction of the background environment. Insertion of the synthetic depiction of the target into the depiction of the background environment may result in labeling of the synthetic training image of the target for training of a target detection model. In some implementation, operation 206 may be performed by a processor component the same as or similar to the generation component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for generating labeled synthetic data for target detection, the system comprising:
one or more physical processors configured by machine-readable instructions to:
generate a synthetic depiction of a target;
obtain a depiction of a background environment; and
generate a synthetic training image of the target by inserting the synthetic depiction of the target into the depiction of the background environment, wherein insertion of the synthetic depiction of the target into the depiction of the background environment results in labeling of the synthetic training image of the target for training of a target detection model.

2. The system of claim 1, wherein the synthetic depiction of the target is generated using a variational autoencoder.

3. The system of claim 2, wherein the variational autoencoder is a vector quantized variational autoencoder.

4. The system of claim 1, wherein the synthetic depiction of the target is generated using a generative adversarial network.

5. The system of claim 1, wherein the labeling of the synthetic training image for training of the target detection model includes identification of the synthetic training image as including depiction of the target.

6. The system of claim 5, wherein the labeling of the synthetic training image for training of the target detection model further includes determination of location of the synthetic depiction of the target in the synthetic training image.

7. The system of claim 1, wherein the depiction of the background environment is captured via aerial photography.

8. The system of claim 1, wherein the synthetic training image simulates a view of the target captured via aerial photography.

9. The system of claim 1, wherein the background environment includes a homogeneous environment.

10. The system of claim 1, wherein the synthetic depiction of the target is modified for inclusion in the synthetic training image.

11. A method for generating labeled synthetic data for target detection, the method comprising:
generating a synthetic depiction of a target;
obtaining a depiction of a background environment; and
generating a synthetic training image of the target by inserting the synthetic depiction of the target into the depiction of the background environment, wherein insertion of the synthetic depiction of the target into the depiction of the background environment results in labeling of the synthetic training image of the target for training of a target detection model.

12. The method of claim 11, wherein the synthetic depiction of the target is generated using a variational autoencoder.

13. The method of claim 12, wherein the variational autoencoder is a vector quantized variational autoencoder.

14. The method of claim 11, wherein the synthetic depiction of the target is generated using a generative adversarial network.

15. The method of claim 11, wherein the labeling of the synthetic training image for training of the target detection model includes identification of the synthetic training image as including depiction of the target.

16. The method of claim 15, wherein the labeling of the synthetic training image for training of the target detection model further includes determination of location of the synthetic depiction of the target in the synthetic training image.

17. The method of claim 11, wherein the depiction of the background environment is captured via aerial photography.

18. The method of claim 11, wherein the synthetic training image simulates a view of the target captured via aerial photography.

19. The method of claim 11, wherein the background environment includes a homogeneous environment.

20. The method of claim 11, wherein the synthetic depiction of the target is modified for inclusion in the synthetic training image.
